(19) United States
(12) Patent Application Publication
(10) Pub. No.: US 2008/0229767 A1
(43) Pub. Date: Sep. 25, 2008

(54) Method and Device for Controlling Refrigeration Cycle of Air conditioning System for Vehicle

(75) Inventors: Kojiro Nakamura, Tochigi (JP); Tomohiro Maruyama, Gunma (JP)

Correspondence Address: FOLEY AND LARDNER LLP;SUITE 500, 3000 K STREET NW, WASHINGTON, DC, 20007, US

(73) Assignee: Calsonic Kansei Corporation

(21) Appl. No.: 10/586,680

(22) PCT Filed: Dec. 16, 2004
(86) PCT No.: PCT/JP2004/019271

§ 371 Date: Jul. 20, 2006

(30) Foreign Application Priority Data
Jan. 22, 2004 (JP) 2004-014200

(51) Int. Cl. B60H 1/32; G05B 19/00; F25B 1/00; F25B 49/00

(52) U.S. Cl. 62/133; 700/276; 62/228.4; 62/229; 62/230

(57) ABSTRACT

In an air conditioning system having a variable displacement compressor driven by an engine of a vehicle, method and device for controlling a refrigeration cycle are provided to ensure necessary cooling performance of the system without damaging the traveling performance of the vehicle. In the method, a limit value in the discharge rate of the variable displacement compressor is determined by an engine speed or a variable related to the engine speed. The variable displacement compressor is controlled on the basis of the limit value.

### TECHNICAL FIELD

The present invention relates to method and device for controlling a refrigeration cycle of an air conditioning system for a vehicle, which is equipped with a variable displacement compressor driven by an engine.

### BACKGROUND ART

In the air conditioning system having the variable displacement compressor driven by an engine as a power source, it is required at a vehicle's acceleration to make sure of necessary cooling capability without damaging a vehicle's acceleration performance. In order to solve such a problem, Japanese Patent Application Laid-open No. 2003-80935 discloses a control method of refrigeration cycle of an air conditioning system for a vehicle.

In the disclosed air conditioning system, there are provided acceleration judging means for judging an acceleration degree of the vehicle and control determining means for determining a control pattern for a load of the variable displacement compressor against the engine corresponding to judgment of the acceleration degree. In operation, at a vehicle's acceleration, the capacity of the compressor is controlled so that its load accords with a determined control pattern.

In detail, the control determining means determines a required reduction in the load of the compressor corresponding to the judgment of the acceleration judging means. In operation, the control determining means controls the capacity of the compressor so that a load on the compressor is reduced by a required reduction at the beginning of a vehicle's acceleration. Subsequently, the control determining means controls to increase the capacity of the compressor gradually.

In the disclosed air conditioning system, the acceleration judging means is adapted so as to judge the acceleration degree of a vehicle on the basis of a vehicle speed and an accelerator opening or the vehicle speed and a throttle opening.

In the above system, additionally, a compressor torque is calculated by a controlled-current signal to control the capacity of the compressor from its outside, a discharged refrigerant pressure of the compressor and the number of revolutions of the engine (i.e. engine speed). Next, a target compressor torque is determined by subtracting a required reduction torque from the so-calculated compressor torque. Then, a target control current is determined on the basis of the target compressor torque, the discharged refrigerant pressure of the compressor and the engine speed. At a vehicle accelerating, the capacity of the compressor is controlled by the above target control current.

In the above-mentioned system, however, there is a possibility that the cooling power becomes excessive when the engine continues to be driven at a high engine speed in spite of no judgment of accelerating (e.g. vehicle's traveling at high speed, traveling on a slope road, etc.). In the situation of no judgment of a vehicle's acceleration, if trying to control the capacity of the compressor corresponding to a temperature of a vehicle cabin, the operational loss of the system may be increased due to hunting operation, excessive cooling and so on.

Additionally, if the ON/OFF state in an accelerator pedal is repeated at a vehicle's traveling on a slope road (continuation of high traveling load), the control in operation of the system is complicated.

### DISCLOSURE OF INVENTION

In the above-mentioned situation, it is an object of the present invention to ensure necessary cooling performance in an air conditioning system equipped with a variable displacement compressor driven by an engine of vehicle without damaging the traveling performance of the vehicle.

It is another object of the present invention to prevent an excessive cooling operation of the air conditioning system while simplifying the control of the air conditioning system.

In order to solve the above-mentioned objects, according to the present invention, there is provided a control method of controlling a refrigeration cycle of an air conditioning system for a vehicle, which is equipped with a variable displacement compressor driven by an engine, the method comprising the steps of: determining a limit value of a discharge rate of the variable displacement compressor by an engine speed or a variable related to the engine speed; and controlling an operation of the variable displacement compressor on the basis of the limit value.

According to the present invention, there is also provided a control device of controlling a refrigeration cycle of an air conditioning system for a vehicle, which is equipped with a variable displacement compressor driven by an engine, the control device comprising: a limit-value determining unit for determining a limit value of a discharge rate of the variable displacement compressor by an engine speed or a variable related to the engine speed; and a discharge-rate controlling unit for controlling an operation of the variable displacement compressor on the basis of the limit value.

These and other objects and features of the present invention will become more fully apparent from the following description and appended claims taken in conjunction with the accompany drawings.

### BRIEF DESCRIPTION OF DRAWINGS

FIG. 1 is a schematic structural view of an air conditioning system including a control device in accordance with the first embodiment of the present invention;

FIG. 2 is a flow chart showing a control method in accordance with the first embodiment of the present invention;

FIG. 3 is a schematic structural view of an air conditioning system including a control device in accordance with the second embodiment of the present invention;

FIG. 4 is a flow chart showing a control method in accordance with the second embodiment of the present invention;

FIG. 5 is a flow chart showing the control method in accordance with the second embodiment of the present invention;

FIG. 6 is a schematic structural view of an air conditioning system including a control device in accordance with the third embodiment of the present invention;

FIG. 7 is a flow chart showing a control method in accordance with the third embodiment of the present invention;

FIG. 8 is a schematic structural view of an air conditioning system including a control device in accordance with the fourth embodiment of the present invention;

FIG. 9 is a flow chart showing a control method in accordance with the fourth embodiment of the present invention;

FIG. 10 is a flow chart showing the control method in accordance with the fourth embodiment of the present invention;

FIG. 11 is a graph showing the control method in accordance with the first embodiment of the present invention; and

FIG. 12 is a graph showing the control method in accordance with the second embodiment of the present invention.

### BEST MODE FOR CARRYING OUT THE INVENTION

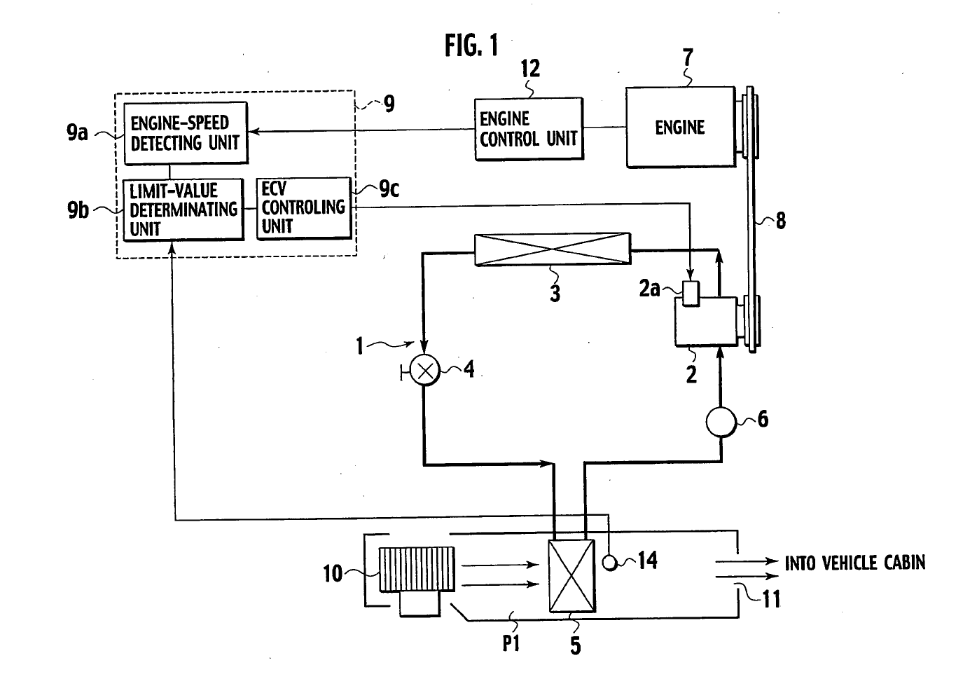

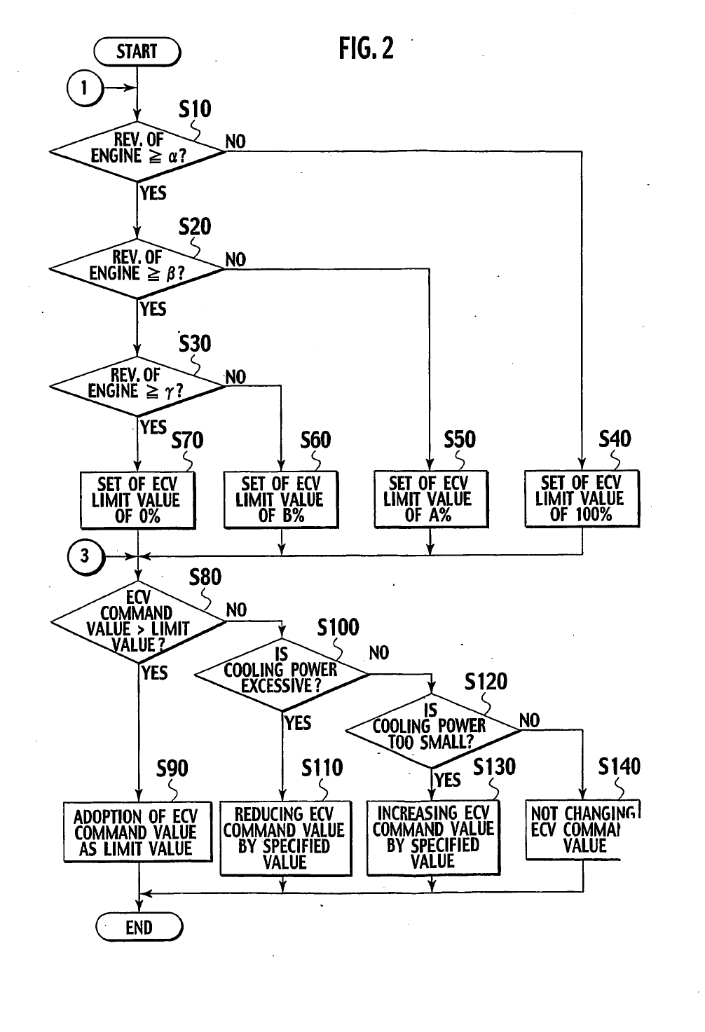

Referring to accompanying drawings, embodiments of the present invention will be described below. FIG. 1 is a schematic structural view of an air conditioning system for a vehicle, which includes a control device in accordance with the first embodiment of the present invention. FIG. 2 is a flow chart showing a control method in accordance with the first embodiment of the present invention.

This air conditioning system includes a refrigeration cycle 1 carrying out heat exchange between refrigerant and air by circulating the refrigerant in the cycle 1.

The refrigeration cycle 1 includes a variable displacement compressor 2, a condenser 3, a pressure reducing device 4, an evaporator 5 and an accumulator 6, which are successively communicatively connected with each other through piping members. With the constitution, the refrigeration cycle 1 is constructed so as to allow the refrigerant having kinetic energy due to the variable displacement compressor 2 to circulate through these constituents.

The variable displacement compressor 2 is arranged outside a vehicle cabin, such as engine room. In operation, the variable displacement compressor 2 compresses low-pressure gaseous refrigerant inhaled therein and successively exhales the resulting high-pressure gaseous refrigerant. This variable displacement compressor 2 is driven by a crankshaft (not shown) of an engine 7 through a transmission mechanism 8. The variable displacement compressor 2 is formed by a so-called “swash-plate type” compressor that has a not-shown swash plate whose inclination is controlled by electrical signals inputted from the outside.

In detail, the variable displacement compressor 2 is provided with an external control valve (ECV) 2a, such as solenoid valve, controlled by outside electrical signals. For instance, if the ECV 2a is formed by a solenoid valve in communication with the high-pressure side of the compressor 2, the interior of a crankcase is communicated with the low-pressure side of the compressor 2 through a passage having a designated opening degree, so that a pressure in the crankcase can be released to the low-pressure side of the compressor 2. That is, the pressure in the crankcase can be controlled by activating or inactivating the solenoid valve to introduce or interrupt a pressure on the high-pressure side. In this way, by controlling the pressure in the crankcase, the balance of pressure on a piston in the compressor 2 can be varied to change an inclination of the swash plate, whereby it becomes possible to control a discharge rate of the variable displacement compressor 2.

In order to operate the solenoid valve, a control amplifier 9 also controlling the whole operation of the air conditioning system outputs duty signals of an appropriate duty ratio to the solenoid valve. The opening period of the solenoid valve is determined corresponding to a value of the variable displacement compressor 2.

The condenser 3 is arranged outside the vehicle cabin to radiate heat of the gaseous refrigerant of high temperature and high pressure discharged from the variable displacement compressor 2. The condenser 3 is adapted so as to take ambient air from blower means, such as electric fan.

Due to heat exchange between the high-temperature and high-pressure gaseous refrigerant flowing in the condenser 3 and the ambient air blown against the condenser 3, it operates to radiate heat of the high-temperature and high-pressure gaseous refrigerant to the outside.

The pressure reducing device 4 operates to rapidly expand liquid refrigerant as a result of heat radiation by the condenser 3 and further supplies the evaporator 5 with low-temperature and low-pressure refrigerant in the form of mist.

The evaporator 5 is provided to make the “misty” low-temperature and low-pressure refrigerant from the pressure reducing device 4 absorb heat of air flowing in an in-cabin air passage P1. Then, the above refrigerant supplied from the pressure reducing device 4 to the evaporator 5 vaporizes due to heat of air flowing in the passage P1 when the refrigerant passes through the evaporator 5. Air after endothermal reaction of the refrigerant in the evaporator 5 is dehumidified in the form of cold air and subsequently flows to the downstream side of the passage P1.

The accumulator 6 is provided for vapor-liquid separation of the refrigerant discharged from the evaporator 5 and also stores liquid refrigerant. Gaseous refrigerant separated from the liquid refrigerant is sucked into the variable displacement compressor 2 and compressed again.

With the circulation of refrigerant in the above way, the refrigeration cycle 1 generates cold air in the in-cabin air passage P1 due to heat exchange at the condenser 3 and the evaporator 5.

In the in-cabin air passage P1, a heater core (not shown) is arranged on the downstream side of the evaporator 5. The heater core is provided for heat radiation of high-temperature engine cooling water supplied from a water jacket (not shown) of the engine 7 through a piping member (not shown). Consequently, hot air is produced in the passage P1.

A blower fan 10 is arranged on the upstream side of the passage P1. With drive of the blower fan 10, ambient air is introduced from an “ambient air” introductory port into the passage P1. Otherwise, inside air is introduced from an “inside air” introductory port into the passage P1. In the vicinity of the “ambient air” introductory port and the “inside air” introductory port, there is an intake door though it is not shown. With the drive of the intake door, a proportion of the ambient air to the inside air introduced into the passage P1 is controlled.

Air that has been introduced into the passage P1 through the “inside air” introductory port and/or the “ambient air” introductory port passes through the evaporator 5 on the upstream side of the passage P1. Then, the air passing through the evaporator 5 is dehumidified due to the endothermal reaction of the refrigerant in the evaporator 5. Subsequently, the resulting cold air flows to the downstream side of the passage P1.

By an air-mix door (not shown), the air cooled down by the evaporator 5 is distributed into a flow passage passing through the above heater core and another flow passage bypassing the heater core, with an appropriate ratio. Since a ratio in the flow rate of air flowing through the heater core to the other air bypassing the heater core is controlled by controlling the drive of the air-mix door, a temperature of air flowing into the vehicle cabin via an air outlet 11 is controlled finally.

The shown air outlet 11 comprises a defroster outlet for spouting temperature-controlled air against a front windshield glass, a vent outlet for spouting the air against a passenger's upper body, a foot outlet for spouting the air against a passenger's foot and so on. In the vicinity of these outlets, there are respectively arranged a defroster door, a vent door and a foot door that control the flow rates of air spouting out of the outlets.

The control amplifier 9 is formed by a microcomputer including a CPU (central processing unit), a ROM (read only memory) and a RAM (random access memory). The control amplifier 9 is connected to an engine control unit 12 for controlling the engine 7. Indispensable driving information is transmitted from the engine control unit 12 to the control amplifier 9.

The control amplifier 9 includes an engine-speed (rev.) detecting unit 9a, a limit-value determining unit 9b, an ECV controlling unit (discharge-rate controlling unit) 9c, etc. that are respectively formed by programs stored in the ROM. Based on the information from the engine control unit 12, a preset temperature preset by a passenger, a detected value of a sensor 14 for detecting a temperature of air on the outlet side of the evaporator 5, a detected value of a not-shown room-temperature sensor, etc., the control amplifier 9 calculates a duty ratio for the ECV 2a of the variable displacement compressor 2 in order to control its operation.

When the number of revolutions (engine speed) of the engine 7 is high (at a vehicle's acceleration, traveling on a slope road, traveling at a high speed, etc.), the limit-value determining unit 9b determines a limit value so as to reduce the discharge rate of the variable displacement compressor 2. Further judging whether a cooling power of the compressor 2 is appropriate or not, the limit-value determining unit 9b properly alters a command value to the ECV 2a so as to prevent an excessive cooling while ensuring required cooling performance. The ECV controlling unit 9c controls the operation of the ECV 2a based on the so-determined limit value.

The controlling method of the refrigeration cycle 1 by the air conditioning system of this embodiment will be described with reference to a flow chart of FIG. 2.

First, at step S10, it is executed to judge whether the number of revolutions of the engine 7 (i.e. engine speed) is equal to or more than a predetermined value α or not. If the judgment at step S10 is No, then the routine goes to step S40 to establish a limit value of 100% in the duty ratio of the ECV 2a. Consequently, the variable displacement compressor 2 is driven while its discharge rate is not limited.

While, if the judgment at step S10 is Yes, then the routine goes to step S20 where it is judged whether the engine speed is equal to or more than β (β>α) or not. If the judgment at step S20 is No, then the routine goes to step S50 to establish a limit value of A% (0<A<100) in the duty ratio of the ECV 2a. Consequently, the variable displacement compressor 2 is driven at a discharge rate so that the duty ratio does not exceed A%.

If the judgment at step S20 is Yes, then the routine goes to step S30 where it is judged whether the engine speed is equal to or more than γ (γ>β) or not. If the judgment at step S30 is No, then the routine goes to step S60 to establish a limit value of B% (0<B<A) in the duty ratio of the ECV 2a. Consequently, the variable displacement compressor 2 is driven at a discharge rate so that the duty ratio does not exceed B%.

If the judgment at step S30 is Yes, then the routine goes to step S70 to establish a limit value of 0% in the duty ratio of the ECV 2a. That is, the variable displacement compressor 2 is brought into “non-stroke” condition where its discharge rate becomes 0 (zero).

On the establishment of a limit value in the duty ratio of the ECV 2a at steps S40 to S70, it is executed at step S 80 to judge whether a command value in the duty ratio transmitted from the control amplifier 9 to the ECV 2a is equal to or more than the above limit value. If the judgment at step S80 is Yes, then the routine goes to step S90 to set the command value to the limit value.

If the judgment at step S80 is No, then the routine goes to step S100 to judge whether the cooling power is excessive on the basis of a detected value of the sensor 14 for detecting a blowout temperature at the outlet of the evaporator 5. If the judgment at step S100 is Yes (excessive temperature), then the routine goes to step 110 to reduce the command value for the ECV 2a by a specified value.

Meanwhile, if the judgment at step S100 is No, then the routine goes to step S120 to judge whether the cooling power is excessively small on the basis of the detected value of the sensor 14. If the judgment at step S120 is Yes (insufficient temperature), then the routine goes to step 130 to increase the command value for the ECV 2a by the specified value.

If the judgment at step S120 is No, the routine goes to step S140 to employ the command value for the ECV 2a as it is.

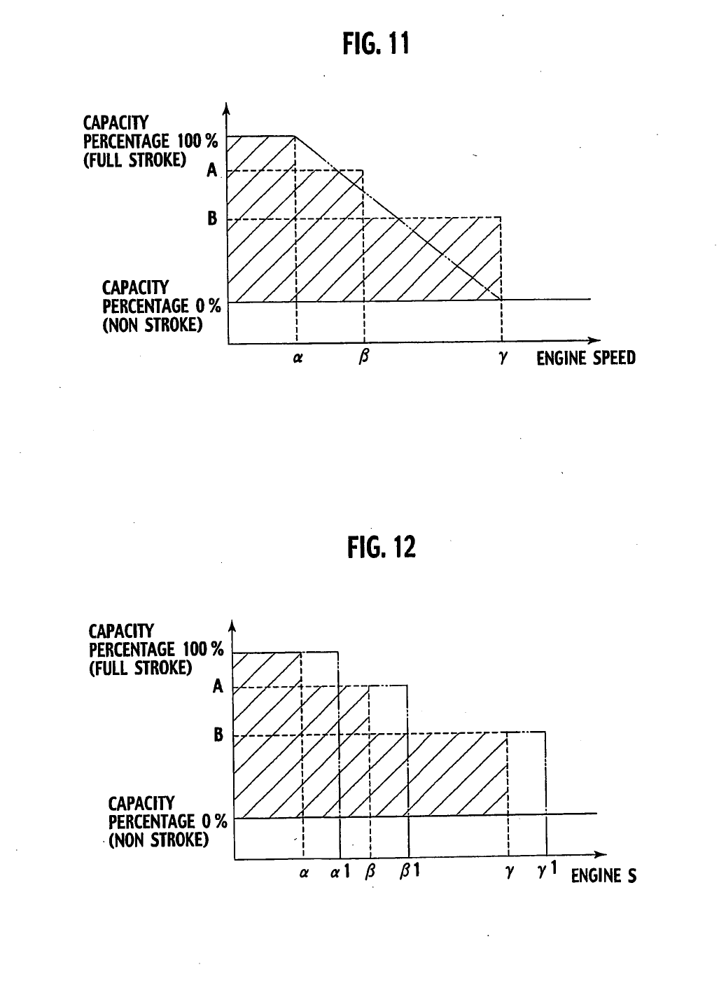

FIG. 11 is an image diagram of the above-mentioned controlling method of the above embodiment. In the figure, an X-axis denotes the number of revolutions of the engine 7, while a Y-axis denotes the percentage (duty ratio) in the discharge rate of the variable displacement compressor 2. Also, a shaded area designates a usable range of the variable displacement compressor 2.

As shown in the figure, the limit value of the percentage in the discharge rate of the compressor 2 changes in stages corresponding to a magnitude of the number of revolutions of the engine 7. Noted, the number of stages having the limit values changed may be established optionally. Alternatively, as shown with a chain double-dashed line of FIG. 11, the limit value may be changed linearly.

According to the above-mentioned controlling method, since the limit value is determined so as to decrease the discharge rate of the compressor 2 under various conditions (e.g. accelerating, traveling on slope road, traveling at high speed, etc.) that the number of revolutions of the engine 7 becomes high, it is possible to reduce an engine load, whereby the traveling performance can be improved.

In addition, since excessive cooling can be prevented while ensuring cooling performance required to the compressor 2, it is possible to improve fuel consumption of the vehicle.

It is noted that the above-mentioned embodiment has advantages of simplicity in control and production with ease and low price.

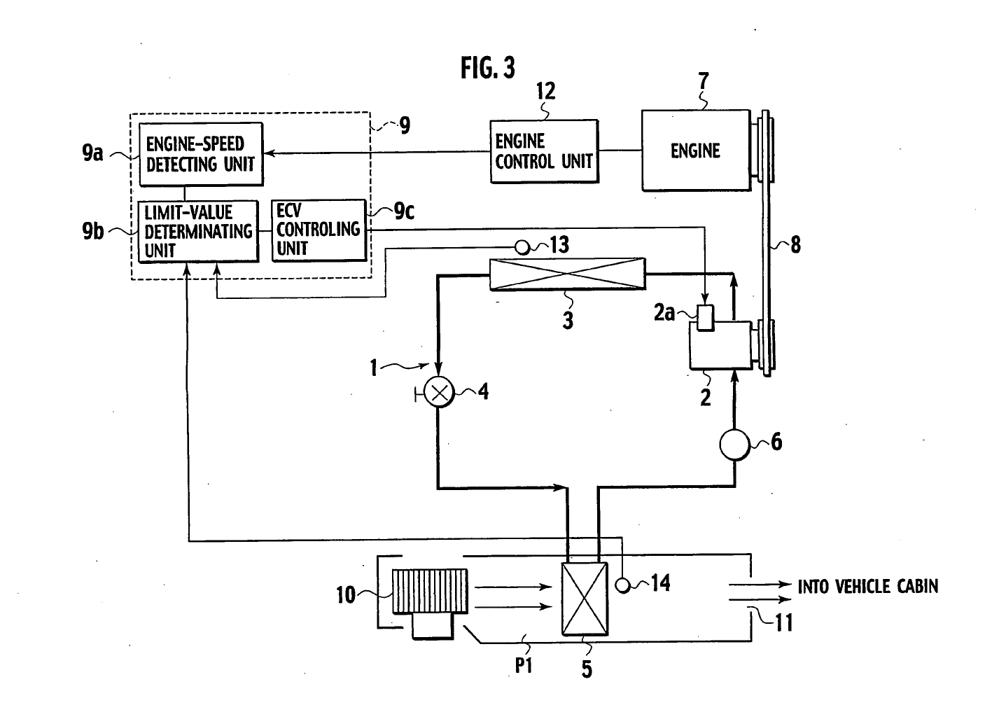

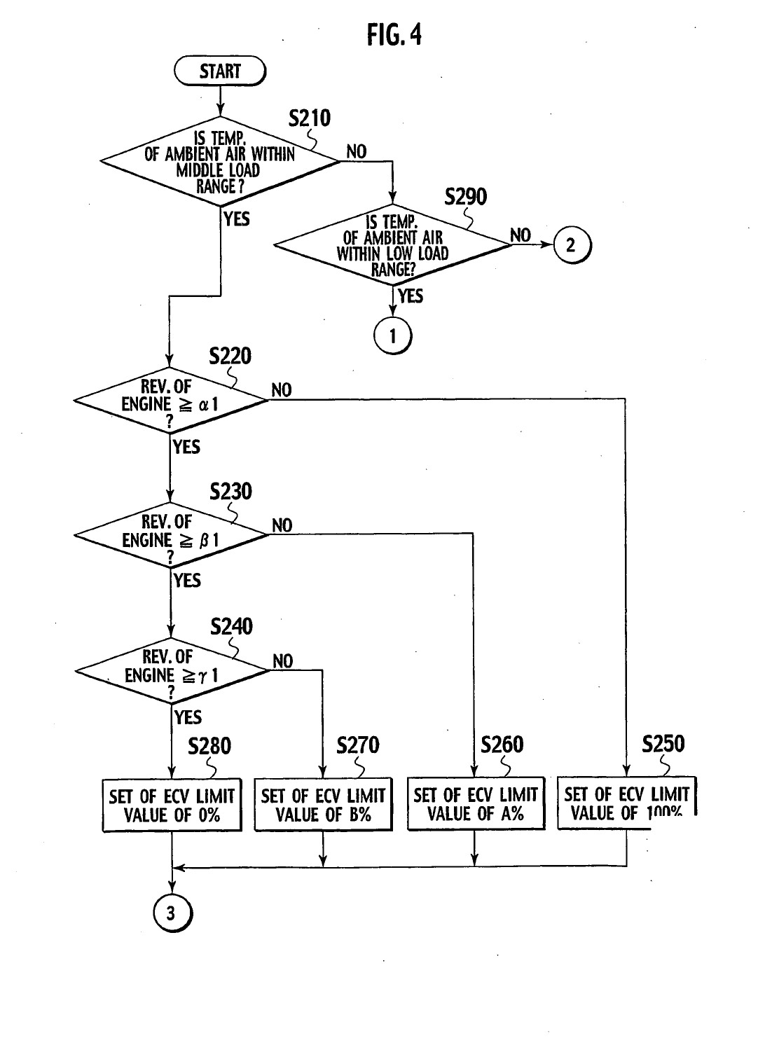

Next, the second embodiment will be described below. FIG. 3 is a schematic structural view of an air conditioning system including a control device of the second embodiment of the present invention. FIG. 4 is a flow chart showing a control method of the second embodiment. Noted, in the following embodiments, element identical or similar to those of the first embodiment will be indicated with the same reference numerals respectively and their overlapping descriptions are eliminated.

In the second embodiment, as shown in FIG. 3, an ambient air temperature sensor 13 is added to the system of the first embodiment. The control amplifier 9 calculates the duty ratio for the ECV 2a of the compressor 2 while adding a detected value by the sensor 13 to the information of the first embodiment, controlling the operation of the variable displacement compressor 2.

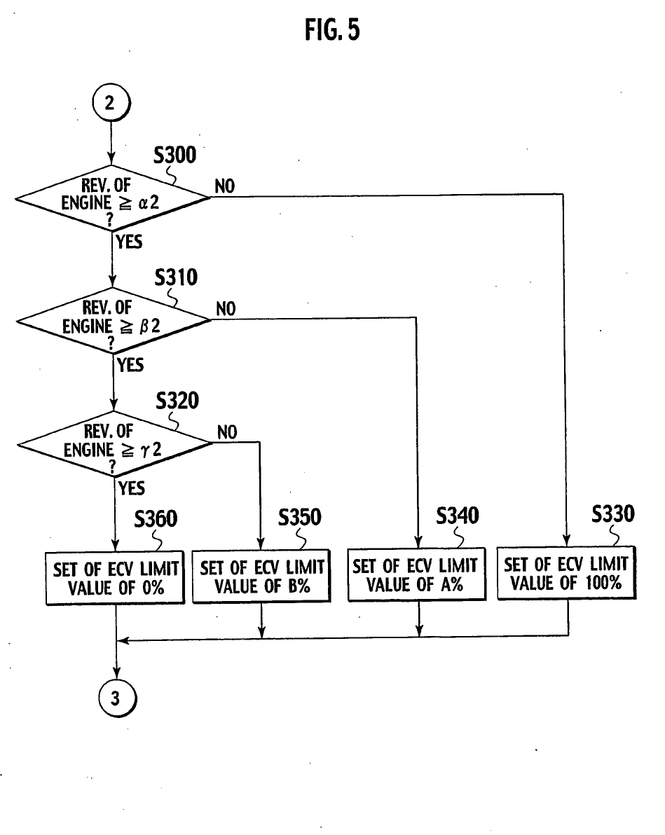

The controlling method of the refrigeration cycle 1 by the air conditioning system of the second embodiment will be described with reference to FIGS. 4 and 5.

First, at step S210, it is executed to judge whether an ambient air temperature is within the temperature range of a middle load by a detected value of the ambient air temperature sensor 13 or not. If the judgment at step S210 is Yes, then the routine goes to step S220 where it is judged whether the number of revolutions of the engine 7 (i.e. engine speed) is equal to or more than a predetermined value α1 (α>0) or not. If the judgment at step S220 is No, then the routine goes to step S250 to establish a limit value of 100% in the duty ratio of the ECV 2a. Consequently, the variable displacement compressor 2 is driven while its discharge rate is not limited.

While, if the judgment at step S220 is Yes, then the routine goes to step S230 where it is judged whether the engine speed is equal to or more than β1 (β1>α1, β1>β) or not. If the judgment at step S230 is No, then the routine goes to step S260 to establish a limit value of A % (0<A<100) in the duty ratio of the ECV 2a. Consequently, the variable displacement compressor 2 is driven at a discharge rate so that the duty ratio does not exceed A%.

If the judgment at step S230 is Yes, then the routine goes to step S240 where it is judged whether the engine speed is equal to or more than γ1 (γ1>β1, γ1>γ) or not. If the judgment at step S240 is No, then the routine goes to step S270 to establish a limit value of B% (0<B<A) in the duty ratio of the ECV 2a. Consequently, the variable displacement compressor 2 is driven at a discharge rate so that the duty ratio does not exceed B%.

If the judgment at step S240 is Yes, then the routine goes to step S280 to establish a limit value of 0% in the duty ratio of the ECV 2a. That is, the variable displacement compressor 2 is brought into “non-stroke” condition where its discharge rate becomes 0 (zero).

Noted, if the judgment at step S210 is No, then the routine goes to step S290 where it is judged whether the ambient air temperature is within the temperature range of a low load. If the judgment at step S290 is Yes, the routine goes to step S10 to carry out the control of the first embodiment without carrying out the control of the second embodiment.

If the judgment at step S290 is No, that is, when the ambient air temperature is within the temperature range of a high load, then the routine goes to step S300 of FIG. 5 where it is judged whether the number of revolutions of the engine 7 (i.e. engine speed) is equal to or more than a predetermined value α2 (α2>α1) or not. If the judgment at step S300 is No, then the routine goes to step S330 to establish a limit value of 100% in the duty ratio of the ECV 2a. Consequently, the variable displacement compressor 2 is driven while its discharge rate is not limited.

While, if the judgment at step S300 is Yes, then the routine goes to step S310 where it is judged whether the engine speed is equal to or more than β2 (β2>α2>, β2>β1) or not. If the judgment at step S310 is No, then the routine goes to step S340 to establish a limit value of A% (0<A<100) in the duty ratio of the ECV 2a. Consequently, the variable displacement compressor 2 is driven at a discharge rate so that the duty ratio does not exceed A%.

If the judgment at step S310 is Yes, then the routine goes to step S320 where it is judged whether the engine speed is equal to or more than γ2 (γ2>β2, γ2>γ1) or not. If the judgment at step S320 is No, then the routine goes to step S350 to establish a limit value of B% (0<B<A) in the duty ratio of the ECV 2a. Consequently, the variable displacement compressor 2 is driven at a discharge rate so that the duty ratio does not exceed B%.

If the judgment at step S320 is Yes, then the routine goes to step S360 to establish a limit value of 0% in the duty ratio of the ECV 2a. That is, the variable displacement compressor 2 is brought into “non-stroke” condition where its discharge rate becomes 0 (zero).

On the establishment of a limit value in the duty ratio of the ECV 2a at steps S40 to S70, S250 to S280 and S330 to S360, it is executed at step S 80 to judge whether a command value in the duty ratio transmitted from the control amplifier 9 to the ECV 2a is more than the above limit value. If the judgment at step S80 is Yes, then the routine goes to step S90 to set the command value to the limit value.

If the judgment at step S80 is No, then the routine goes to step S100 to judge whether the cooling power is excessive on the basis of a detected value of the sensor 14 for detecting a blowout temperature at the outlet of the evaporator 5. If the judgment at step S100 is Yes (excessive temperature), then the routine goes to step S110 to reduce the command value for the ECV 2a by a specified value.

Meanwhile, if the judgment at step S100 is No, then the routine goes to step S120 to judge whether the cooling power is excessively small on the basis of the detected value of the sensor 14. If the judgment at step S120 is Yes (insufficient temperature), then the routine goes to step S130 to increase the command value for the ECV 2a by the specified value.

If the judgment at step S120 is No, the routine goes to step S140 to employ the command value for the ECV 2a as it is.

FIG. 12 is an image diagram of the above-mentioned controlling method of the second embodiment. In the first embodiment, the shaded area designates the usable range of the variable displacement compressor 2. While, a threshold value (engine speed) for establishing the percentage (duty ratio) in the discharge rate of the variable displacement compressor 2 changes corresponding to an ambient air temperature in the second embodiment. Therefore, for example, if the ambient air temperature is within the range of the middle load, then the usable range of the variable displacement compressor 2 varies as shown with chain double-dashed lines of the figure.

In this way, by making a threshold value higher as the load of an ambient air gets higher, it is possible to avoid an occurrence of situation that the present cooling performance comes short of a required one.

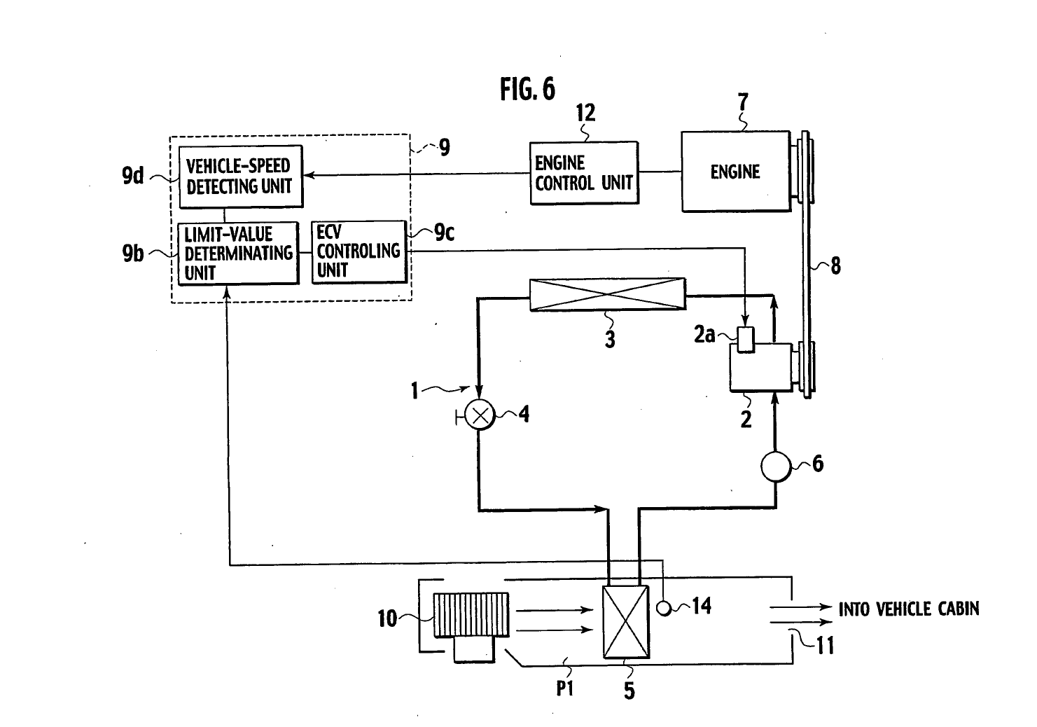

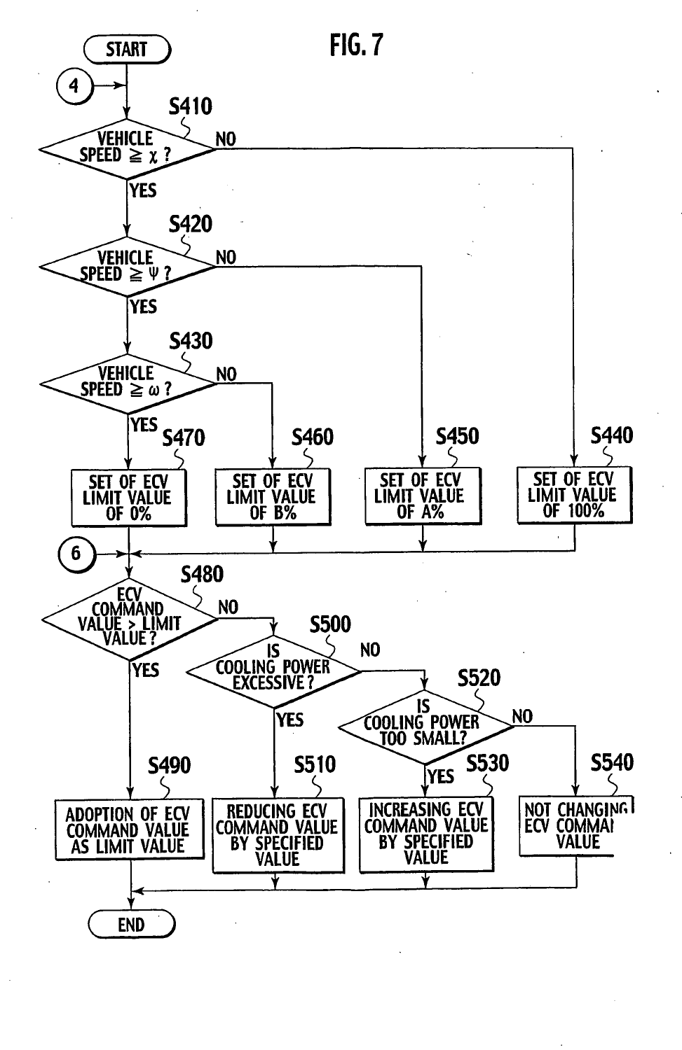

Next, the third embodiment will be described below. FIG. 6 is a schematic structural view of an air conditioning system including a control device of the third embodiment of the present invention. FIG. 7 is a flow chart showing a control method of the third embodiment.

In the third embodiment, the control amplifier 9 is provided with a vehicle-speed detecting unit 9d in place of the engine-speed detecting unit 9a of the first embodiment.

Next, the controlling method of the refrigeration cycle 1 by the air conditioning system of the third embodiment will be described with reference to FIG. 7.

First, at step S410, it is executed to judge whether the vehicle speed is equal to or more than a predetermined value χ or not. If the judgment at step S410 is No, then the routine goes to step S440 to establish a limit value of 100% in the duty ratio of the ECV 2a. Consequently, the variable displacement compressor 2 is driven while its discharge rate is not limited.

While, if the judgment at step S410 is Yes, then the routine goes to step S420 where it is judged whether the vehicle speed is equal to or more than φ(φ>χ) or not. If the judgment at step S420 is No, then the routine goes to step S450 to establish a limit value of A% (0<A<100) in the duty ratio of the ECV 2a. Consequently, the variable displacement compressor 2 is driven at a discharge rate so that the duty ratio does not exceed A%.

If the judgment at step S420 is Yes, then the routine goes to step S430 where it is judged whether the engine speed is equal to or more than ω (ω>φ) or not. If the judgment at step S430 is No, then the routine goes to step S460 to establish a limit value of B% (0<B<A) in the duty ratio of the ECV 2a. Consequently, the variable displacement compressor 2 is driven at a discharge rate so that the duty ratio does not exceed B%.

If the judgment at step S430 is Yes, then the routine goes to step S470 to establish a limit value of 0% in the duty ratio of the ECV 2a. That is, the variable displacement compressor 2 is brought into “non-stroke” condition where its discharge rate becomes 0 (zero).

After completing to establish a limit value in the duty ratio of the ECV 2a at steps S440 to S470, it is executed at step S480 to judge whether a command value in the duty ratio transmitted from the control amplifier 9 to the ECV 2a is more than the above limit value. If the judgment at step S480 is Yes, then the routine goes to step S490 to set the command value to the limit value.

If the judgment at step S480 is No, then the routine goes to step S500 to judge whether the cooling power is excessive on the basis of a detected value of the sensor 14 for detecting a blowout temperature at the outlet of the evaporator 5. If the judgment at step S500 is Yes (excessive temperature), then the routine goes to step S510 to reduce the command value for the ECV 2a by a specified value.

Meanwhile, if the judgment at step S510 is No, then the routine goes to step S520 to judge whether the cooling power is excessively small on the basis of the detected value of the sensor 14. If the judgment at step S520 is Yes (insufficient temperature), then the routine goes to step S530 to increase the command value for the ECV 2a by the specified value.

If the judgment at step S520 is No, the routine goes to step S540 to employ the command value for the ECV 2a as it is.

According to the above-mentioned controlling method, since the limit value is determined so as to decrease the discharge rate of the compressor 2 under condition that the vehicle speed is high, it is possible to reduce an engine load, whereby the traveling performance can be improved.

In addition, since excessive cooling can be prevented while ensuring cooling performance required to the compressor 2, it is possible to improve fuel consumption of the vehicle.

It is noted that the above-mentioned embodiment has advantages of simplicity in control and production with ease and low price.

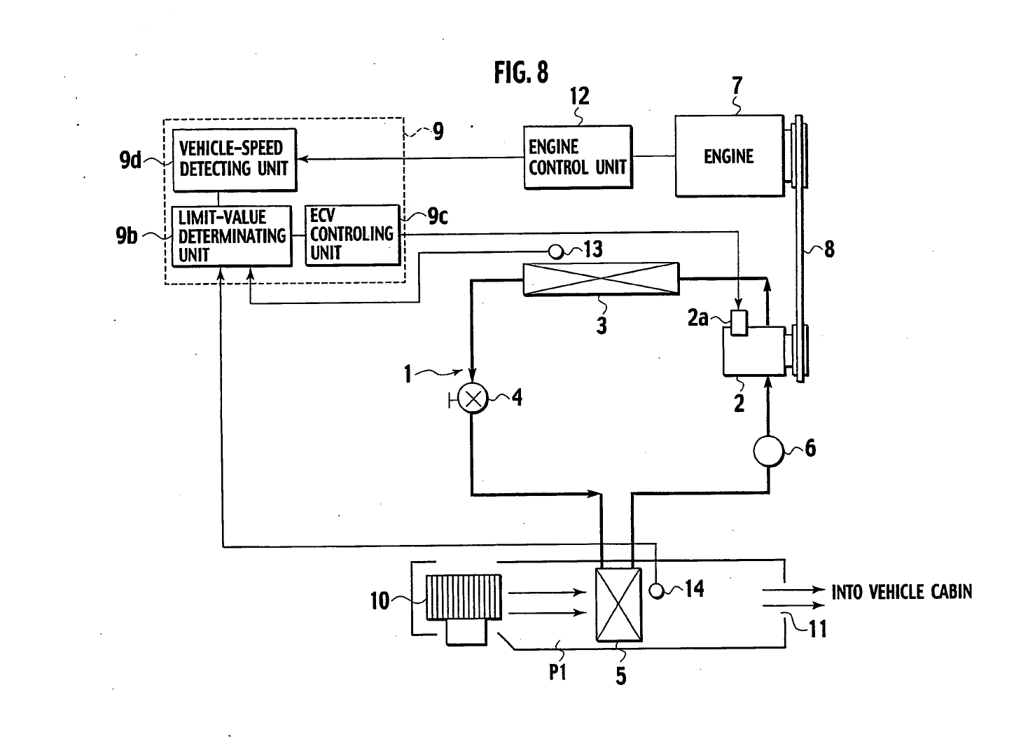

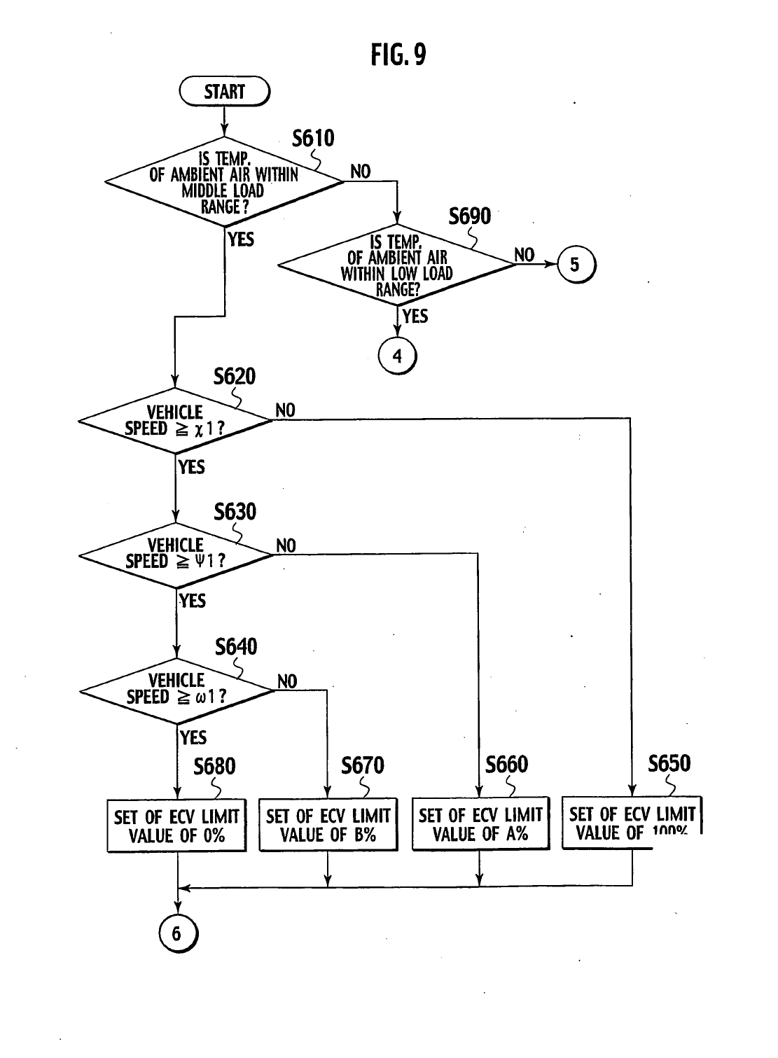

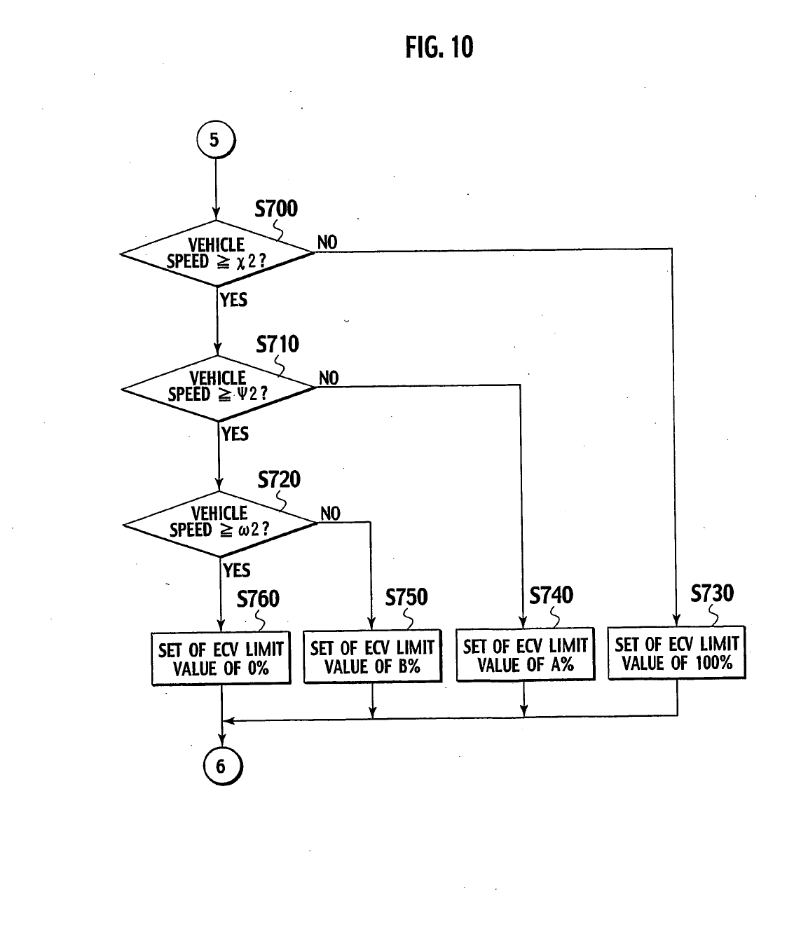

Next, the fourth embodiment will be described below. FIG. 8 is a schematic structural view of an air conditioning system including a control device of the fourth embodiment of the present invention. FIGS. 9 and 10 are flow charts showing a control method of the fourth embodiment.

In the fourth embodiment, as shown in FIG. 8, the ambient air temperature sensor 13 is added to the system of the third embodiment. The control amplifier 9 calculates the duty ratio for the ECV 2a of the compressor 2 while adding a detected value by the sensor 13, controlling the operation of the variable displacement compressor 2.

The controlling method of the refrigeration cycle 1 by the air conditioning system of the fourth embodiment will be described with reference to FIGS. 9 and 10.

First, at step S610, it is executed to judge whether an ambient air temperature is within the temperature range of a middle load by a detected value of the ambient air temperature sensor 13 or not. If the judgment at step S610 is Yes, then the routine goes to step S620 where it is judged whether the vehicle speed is equal to or more than a predetermined value χ1 (χ1>χ) or not. If the judgment at step S620 is No, then the routine goes to step S650 to establish a limit value of 100% in the duty ratio of the ECV 2a. Consequently, the variable displacement compressor 2 is driven while its discharge rate is not limited.

While, if the judgment at step S620 is Yes, then the routine goes to step S630 where it is judged whether the vehicle speed is equal to or more than φ1 (φ1>χ1, φ1>φ) or not. If the judgment at step S630 is No, then the routine goes to step S660 to establish a limit value of A% (0<A<100) in the duty ratio of the ECV 2a. Consequently, the variable displacement compressor 2 is driven at a discharge rate so that the duty ratio does not exceed A%.

If the judgment at step S630 is Yes, then the routine goes to step S640 where it is judged whether the vehicle speed is equal to or more than ω1 (ω1>φ1, ω1>ω) or not. If the judgment at step S640 is No, then the routine goes to step S670 to establish a limit value of B% (0<B<A) in the duty ratio of the ECV 2a. Consequently, the variable displacement compressor 2 is driven at a discharge rate so that the duty ratio does not exceed B%.

If the judgment at step S640 is Yes, then the routine goes to step S680 to establish a limit value of 0% in the duty ratio of the ECV 2a. That is, the variable displacement compressor 2 is brought into “non-stroke” condition where its discharge rate becomes 0 (zero).

Noted, if the judgment at step S610 is No, then the routine goes to step S690 where it is judged whether the ambient air temperature is within the temperature range of a low load. If the judgment at step S690 is Yes, the routine goes to step S410 to carry out the control of the third embodiment without carrying out the control of the fourth embodiment.

If the judgment at step S690 is No, that is, when the ambient air temperature is within the temperature range of a high load, then the routine goes to step S700 of FIG. 10 where it is judged whether the vehicle speed is equal to or more than a predetermined value χ2 (χ2>χ1) or not. If the judgment at step S700 is No, then the routine goes to step S730 to establish a limit value of 100% in the duty ratio of the ECV 2a. Consequently, the variable displacement compressor 2 is driven while its discharge rate is not limited.

While, if the judgment at step S700 is Yes, then the routine goes to step S710 where it is judged whether the vehicle speed is equal to or more than φ2 (φ2>χ2, φ2>φ1) or not. If the judgment at step S710 is No, then the routine goes to step S740 to establish a limit value of A% (0<A<100) in the duty ratio of the ECV 2a. Consequently, the variable displacement compressor 2 is driven at a discharge rate so that the duty ratio does not exceed A%.

If the judgment at step S710 is Yes, then the routine goes to step S720 where it is judged whether the vehicle speed is equal to or more than ω2 (ω2>φ2, ω2>ω1) or not. If the judgment at step S720 is No, then the routine goes to step S350 to establish a limit value of B% (0<B<A) in the duty ratio of the ECV 2a. Consequently, the variable displacement compressor 2 is driven at a discharge rate so that the duty ratio does not exceed B%.

If the judgment at step S720 is Yes, then the routine goes to step S760 to establish a limit value of 0% in the duty ratio of the ECV 2a. That is, the variable displacement compressor 2 is brought into “non-stroke” condition where its discharge rate becomes 0 (zero).

On the establishment of a limit value in the duty ratio of the ECV 2a at steps S440 to S470, S650 to S680 and S730 to S760, it is executed at step S 480 of FIG. 7 to judge whether a command value in the duty ratio transmitted from the control amplifier 9 to the ECV 2a is equal to or more than the above limit value. If the judgment at step S480 is Yes, then the routine goes to step S490 to set the command value to the limit value.

If the judgment at step S480 is No, then the routine goes to step S500 to judge whether the cooling power is excessive on the basis of a detected value of the sensor 14 for detecting a blowout temperature at the outlet of the evaporator 5. If the judgment at step S500 is Yes (excessive temperature), then the routine goes to step S510 to reduce the command value for the ECV 2a by a specified value.

Meanwhile, if the judgment at step S500 is No, then the routine goes to step S520 to judge whether the cooling power is excessively small on the basis of the detected value of the sensor 14. If the judgment at step S520 is Yes, then the routine goes to step S530 to increase the command value for the ECV 2a by the specified value.

If the judgment at step S520 is No, the routine goes to step S540 to employ the command value for the ECV 2a as it is.

In this way, by making a threshold value higher as the load of an ambient air gets higher, it is possible to avoid an occurrence of situation that the present cooling performance comes short of a required one.

Noted, as the limit value, there may be adopted the smaller one of the limit value determined by the engine speed and the limit value determined by the vehicle speed. Then, it becomes possible to improve the traveling performance of a vehicle and also its fuel consumption more certainly.

In connection, if determining the limit value determined by the engine speed and the limit value determined by the vehicle speed in consideration of an ambient air load, then the vehicle can be improved with respect to comfort furthermore.

It is noted that the control method and device of the present invention would be more effective on the application to a CO₂ air conditioner that requires a high torque to drive a compressor.

Finally, it will be understood by those skilled in the art that the foregoing descriptions are nothing but four embodiments of the disclosed control method and device and therefore, various changes and modifications may be made within the scope of claims.

### INDUSTRIAL APPLICABILITY

With the above configuration described above, at a high engine speed condition such as an acceleration of the vehicle, slope driving, or high speed driving, a limit value is determined so as to make a discharge rate of the variable displacement compressor lower. Thus, an engine load can be lowered and a drivability can be improved.

Further, in a conventional art, an operation of a variable displacement compressor depends on an engine speed, a cooling power was apt to become excessive when an engine continues to be driven at a high engine speed. In this invention, a necessary cooling power is determined at a high engine speed condition. When the cooling power is excessive, the discharge rate of the variable displacement is controlled to be lower, and thus an excessive cooling can be avoided and a fuel economy can be improved.

1. A control method of controlling a refrigeration cycle of an air conditioning system for a vehicle, which is equipped with a variable displacement compressor driven by an engine, the method comprising the steps of:
determining a limit value of a discharge rate of the variable displacement compressor by an engine speed or a variable related to the engine speed; and
controlling an operation of the variable displacement compressor on the basis of the limit value.

2. The control method of claim 1, wherein the limit value is determined by the engine speed and a load of ambient air.

3. The control method of claim 1, wherein the variable is a vehicle speed.

4. The control method of claim 3, wherein the limit value is determined by the vehicle speed and a load of ambient air.

5. The control method of claim 3, wherein the limit value is a smaller one of a limit value determined by the engine speed and another limit value determined by the vehicle speed.

6. The control method of claim 3, wherein the limit value is a smaller one of a limit value determined by both of the engine speed and a load of ambient air and another limit value determined by both of the vehicle speed and the load of ambient air.

7. The control method of claim 1, further comprising the step of judging whether a cooling power of the air conditioning system is appropriate or not, wherein the operation of the variable displacement compressor is controlled in a manner that the discharge rate gets smaller when it is judged that the cooling power is excessive.

8. The control method of claim 1, wherein the air conditioning system is a CO₂ air conditioner.

9. A control device of controlling a refrigeration cycle of an air conditioning system for a vehicle, which is equipped with a variable displacement compressor driven by an engine, the control device comprising:
a limit-value determining unit for determining a limit value of a discharge rate of the variable displacement compressor by an engine speed or a variable related to the engine speed; and
a discharge-rate controlling unit for controlling an operation of the variable displacement compressor on the basis of the limit value.

10. The control device of claim 9, wherein the limit-value determining unit determines the limit value by the engine speed and a load of ambient air.

11. The control device of claim 9, wherein the limit-value determining unit determines the limit value by a vehicle speed.

12. The control device of claim 11, wherein the limit-value determining unit determines the limit value by the vehicle speed and a load of ambient air.

13. The control device of claim 11, wherein the limit-value determining unit determines the limit value by a smaller one of a limit value determined by the engine speed and another limit value determined by the vehicle speed.

14. The control device of claim 11, wherein the limit-value determining unit determines the limit value by a smaller one of a limit value determined by both of the engine speed and a load of ambient air and another limit value determined by both of the vehicle speed and the load of ambient air.

15. The control device of claim 9, wherein the limit-value determining unit judges whether a cooling power of the air conditioning system is appropriate and further changes a command value for the discharge-rate controlling unit so that the discharge rate of the variable displacement compressor gets smaller when it is judged that the cooling power is excessive.

16. The control device of claim 9, wherein the air conditioning system is a CO₂ air conditioner.
